(19) United States
(12) Patent Application Publication
(10) Pub. No.: US 2006/0116135 A1
(43) Pub. Date: Jun. 1, 2006

(54) Morphology-based text entry system

(76) Inventor: Michael J. Ure, Cupertino, CA (US)

Correspondence Address: Michael J. Ure, 10518 Phil Pl., Cupertino, CA, 95014, US

(21) Appl. No.: 10/683,950

(22) Filed: Oct. 9, 2003

(51) Int. Cl. H04Q 7/20

(52) U.S. Cl. 455/457

(57) ABSTRACT

Touch typing on a telephone keypad is achieved by representing each letter as a combination of two separate symbols appearing on separate keys of a keypad. The keys may be operated by using the thumbs of both hands. In one embodiment, six symbols appearing on six separate keys are used to represent all of the letters A-Z. The six keys may be grouped together or may be split apart with one portion arranged on one side of a device display and another portion arranged on an opposite side of the display. Input may be accelerated in various ways using multiple key presses at the same time.

### BACKGROUND OF THE INVENTION

1. Field of the Invention

The present invention relates to text entry systems.

2. State of the Art

Various manual text entry systems (excluding voice recognition) have emerged to address the need presented by increasing miniaturization. The telephone keypad has been used for many years for text entry. In one such system, the keys are each labeled with three letters of the alphabet, and a particular letter is entered by pressing a key once, twice or three times, corresponding to the order of the desired letter among the three, hence requiring on average two key presses per letter. Text entry using this method is rather laborious; among other reasons, the locations of the various letters on the keys are not easily remembered from one use to the next.

In the Tegic T9™ input system, a similar arrangement is used. However, disambiguation software is used such that a only a single press per desired letter is required. For numbers and symbols, a menu key is provided. Pressing the key causes a menu including a symbols entry and a numbers entry to appear. The user cursors to the desired entry using dedicated cursor keys, then presses the menu key again to select. For numbers, the user presses the corresponding number key(s). For symbols, a “map” is displayed giving a correspondence between a set of symbols and the number keys.

Alternatively, some devices incorporate a miniature QUERTY-like keyboard having keys that are comparatively tiny. If the layout is QUERTY-based, one having some keyboarding skill may locate a desired letter relatively quickly. Effectiveness is increased where the keys of different halves of the keyboard are operated by opposite ones of the user's thumbs, as in the Blackberry™ device from Research in Motion (RIM). Even so, manipulation of the tiny keys remains rather laborious.

Other approaches dispense with keying altogether, in favor of stylus input. Examples include the now-discontinued Apple Newton™ PDA and the Palm™ connected organizer. In the case of the Newton, a “natural” handwriting recognition approach is followed where text is written where it is to appear, using either printing or cursive writing. Such an approach is not well-suited to increasing miniaturization. In the case of the Palm organizer, “unistroke” characters are entered in a separate text entry area using the Graffiti™ text entry system. Some continuity of writing is sacrificed, and a stylus is of course required.

A text entry system is desired that does not require a stylus or the manipulation of tiny keys. A text entry system is also desired that is more versatile and more easily remembered from use to use than existing telephone keypad systems, such that an increasing skill level may be built up.

### SUMMARY OF THE INVENTION

The present invention, generally speaking, provides a text entry system that uses a relatively small number of keys and that is well-adapted to memorization and skill-building. In one aspect of the invention, the text entry system is based on a set of well-chosen, “morphologically significant” symbols, related in pairs, with one such symbol assigned per key. A letter is entered unambiguously by sequentially pressing one or multiple keys, preferably exactly two keys. In another aspect of the invention, the number of symbols in the set is fewer than the number of keys in a telephone keypad. “Extra” keys are assigned to other characters or actions, such as “space,” “period,” backspace,” and return. Different modes of operation are provided, allowing for the entry of numbers, the entry of punctuation, cursoring, etc.

### BRIEF DESCRIPTION OF THE DRAWING

The present invention may be further understood from the following description in conjunction with the appended drawing. In the drawing:

FIG. 1 is a plan diagram of a keypad layout in accordance with one aspect of the present invention;

FIG. 2 is a help graphic that may be displayed during use of a device;

FIG. 3 is a plan diagram of another keypad layout;

FIG. 4 is a block diagram of a hardware arrangement with which the present invention may be used.

FIG. 5 shows an alternative help graphic that may be displayed during use of a device;

FIG. 6 is a diagram of a vertical spacebar operated by the one thumb;

FIG. 7 is a diagram of a vertical spacebar operated by the opposite thumb;

FIG. 8 is a diagram illustrating the use of multiple key presses at a time to enter any one of various common punctuations marks;

FIG. 9 is a diagram of another alternative keypad layout;

FIG. 10 is a diagram illustrating the use of multiple key presses at a time to enter a common punctuation mark or common word beginning with a given letter, with the word “after” being finally selected;

FIG. 11 is a diagram illustrating the use of multiple key presses at a time to enter a common punctuation mark or common word beginning with a given letter, with the punctuation mark ' (apostrophe) being finally selected;

FIG. 12 is a diagram illustrating the use of multiple key presses at a time to enter a word from a DocWords list beginning with a given letter, with the word “thought” being finally selected;

FIG. 13 is a diagram illustrating the use of multiple key presses at a time to enter a word from a MyWords list beginning with a given letter, with the word “target” being finally selected;

FIG. 14 is a diagram illustrating the use of multiple key presses at a time to enter a three-letter combination beginning with a given letter, with the letter combination “aft” being finally selected;

FIG. 15 is a diagram illustrating the use of multiple key presses at a time to enter a three-letter combination beginning with a given letter, with the letter combination “ate” being finally selected;

FIG. 16 is a diagram illustrating the use of multiple key presses at a time to enter a four-letter combination beginning with a given letter, with the letter combination “arti” being finally selected;

FIG. 17 is a diagram illustrating the use of multiple key presses at a time to enter a four-letter combination beginning with a given letter, with the letter combination “anti” being finally selected;

FIG. 18 is a diagram illustrating the use of multiple key presses at a time to enter the letter Q as a two-letter (qu) combination of the letter U;

FIG. 19 is a diagram illustrating the use of multiple key presses at a time to enter numbers using at least ten keys;

FIG. 20 is a diagram illustrating the use of multiple key presses at a time to enter numbers using fewer than ten keys (e.g., six keys);

FIG. 21 is a diagram illustrating cursor manipulation;

FIG. 22 is a diagram illustrating cursor manipulation and text selection;

FIG. 23 is a diagram illustrating graphical selection using recursive quadrisection;

FIG. 24 is a diagram illustrating command entry using a command sequence and multiple key presses at a time;

FIG. 25 is a diagram illustrating using multiple key presses at a time to select any of a number of common command menus;

FIG. 26 iFIG. 26 is a diagram illustrating devices having various key configurations.

### DETAILED DESCRIPTION OF THE PREFERRED EMBODIMENTS

The preferred embodiments of the invention will now be described, readily susceptible to myriad variations based on the principles described herein.

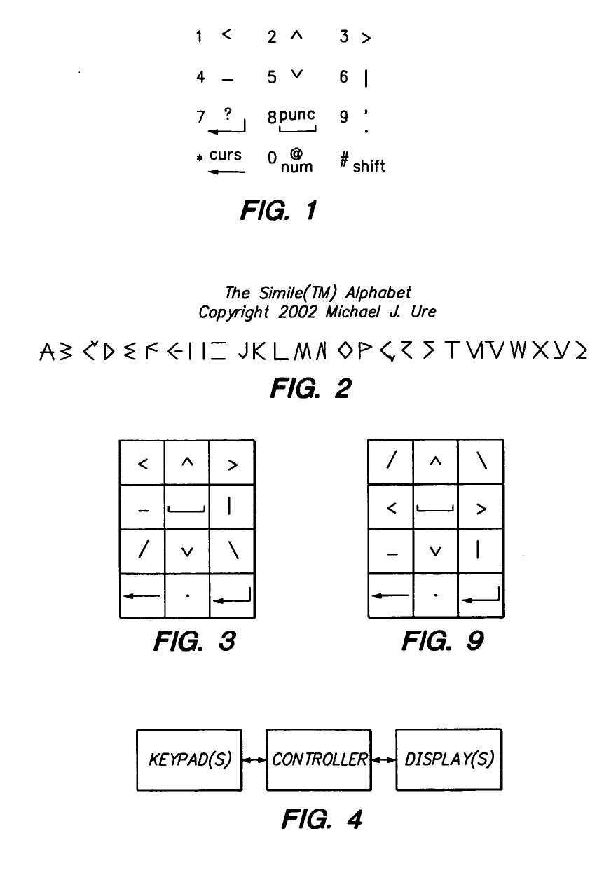

Referring to FIG. 1, a diagram is shown of a keypad layout in accordance with an exemplary embodiment of the invention. The “keys” may be electromechanical or may be purely electrical—i.e., touch keys. Furthermore, the indicia appearing on the keys may be fixed or variable (variable, for example, in the case of touch keys overlying a display). Although the invention principally contemplates activation of the keys by direct touch, activation may also be performed using a stylus.

For purposes of the present description, the keys will be identified by the numbers 0-11, the * key being designated as key 10 and the # key being designated as key 11.

In the illustrated embodiment, the following indicia or symbols appear on the keys:

TABLE 1

| KEY | SYMBOL | KEY | SYMBOL |
|---|---|---|---|
| 1 | < | 7 | [symbol] |
| 2 | [symbol] | 8 | [symbol] |
| 3 | > | 9 | . |
| 4 | _{—} | 10 | [symbol] |
| 5 | [symbol] | 0 | |
| 6 | \| | 11 | |

The symbols appearing on keys 8, 10, 9 and 7 signify “space,” “back-space,” “period,” and “return,” respectively.

The remaining six symbols form a set of well-chosen, “morphologically significant” symbols, related in pairs, including the following pairs: <, >; _, |; and [symbol] , [symbol] .

Although the present text entry system is applicable to a variety of languages and alphabets, its application to the English alphabet will be described. Every letter of the English alphabet is assigned a unique symbol or combination of symbols. Referring to FIG. 2, in a preferred embodiment, each letter is assigned a two-symbol combination. The following combinations are exemplary:

TABLE 2

| Letter | Combination |
|---|---|
| A | [symbol] , _{—} |
| B | >, > |
| C | [symbol] , < |
| D | >, \| |
| E | <, < |
| F | <, \| |
| G | <, _{—} |
| H | \|, \| |
| I | _, _{—} |
| J | \|, [symbol] |
| K | \|, < |
| L | \|, _{—} |
| M | [symbol] , [symbol] |
| N | [symbol] , \| |
| O | <, > |
| P | \|, > |
| Q | <, [symbol] |
| R | _, < |
| S | _, > |
| T | _, \| |
| U | [symbol] , \| |
| V | _, [symbol] |
| W | [symbol] , [symbol] |
| X | [symbol] , [symbol] |
| Y | [symbol] , _{—} |
| Z | >, _{—} |

In other embodiments, the symbols / and \ may also be provided. FIG. 3 shows another embodiment of the keypad using these symbols. As a notational convenience, italic letters may be used to represent the various symbols, as follows: < (left angle) is represented by l, > (right angle) is represented by r, [symbol] (up angle) is represented by u, [symbol] (down angle) is represented by d, _ (horizontal line) is represented by h, | (vertical line) is represented by v, / (slash) is represented by s, and \ (backslash) is represented by b. Using this notation, alternative combinations using s and b may be as follows:

TABLE 3

| Letter | Combination |
|---|---|
| A | u, h |
| B | r, r |
| C | d, l |
| D | r, v |
| E | l, l |
| F | l, v |
| G | l, h |
| H | v, v |
| I | h, h |
| J | v, d |
| K | v, l |
| L | v, h |
| M | u, u |
| N | u, v |
| O | l, r |
| P | v, r |
| Q | l, b |
| R | r, b |
| S | h, r |
| T | h, v |
| U | d, v |
| V | b, s |
| W | d, d |
| X | d, u |
| Y | d, s |
| Z | h, l |

Many other different combinations are possible. Preferably, however, the combinations are suggestive of the form of the printed capital letter, as illustrated in FIG. 2. This feature is made possible by the choice of “morphologically significant” symbols. Note that many possible symbols combinations are unused in the foregoing assignments. These may be assigned for other purposes, including text entry, control, etc.

The layout of FIG. 1 and the assignments of FIG. 2 are particularly advantageous where the keys are to be operated using the thumbs, often in alternating fashion (as in the case of the Blackberry device, for example). Letters are signified using only keys 1-6, keys 1 and 4 being operated by the left thumb and keys 2, 3, 5 and 6 being operated by the right thumb; the “space” key is centrally located; and there is a natural opposition between the symbols of each pair, aiding memorization and the acquisition of skill. Greater locality of motion is achieved, this being the hallmark of touch typing ability. In fact, with a few hours practice (a much shorter learning period than required to learn QUERTY keyboarding), the typical new user is able to enter text with his or her eyes closed.

The symbols described may be provided on the keys in various different ways, such as printing, embossing, display, etc. One type of keypad uses clear plastic keys having printing on the back side of the keys. In this instance, the symbols may be provided as clear ridges or embossings on the surface of the keys, allowing the printing on the back side of the keys to remain clearly visible. Hence, the present text entry system may be provided in addition to other existing text entry systems that rely on markings provided on the keys (or in addition to stylus-based text entry systems). Embossings provide the further advantage of tactile feedback.

Capitalization, numerics, punctuation, cursoring, etc., may be provided for in many different ways. One way, of course, is to simply provide additional keys. Assuming that no additional keys are to be provided, there are still many ways of providing the foregoing features.

Capitalization, for example, may be provided by designating key 11 as a shift key. Alternatively, capitalization may be designated by keeping the initial key depressed for a perceptibly longer time than usual, or by enter two spaces prior to the desired capital letter (as in T9). Cap lock and cap unlock may be provided in toggle fashion by pressing shift twice. Alternatively, cap lock and unlock may be provided in toggle fashion by simultaneously pressing, for example, the “period” key while inputting the first or last of a series of capital letters.

Multiple modes, including a numeric mode, may be provided. Modes may be switched automatically in context-dependent fashion based on device operation. Where manual mode-switching is required, it may be performed, e.g., by pressing the 0 key (numeric mode), shift 10 (cursor mode) or shift 8 (punctuation mode). Alternatively, mode-switching may be performed by, e.g., pressing key 1 for a perceptibly longer duration than normal. In numeric mode, the keys may operate like those of a conventional telephone keypad.

Punctuation may be provided in many different ways. Where manual mode-switching is required, it may be performed as described previously or by, e.g., pressing the “period” key for a perceptibly longer duration than normal. Normally, punctuation mode persists for the entry of one punctuation mark, after which text mode automatically resumes.

In punctuation mode, punctuation marks may be entered, for example, either “morphologically” or by initial letter. The morphological approach is described later. In the case of designation by initial letter, to enter a question mark for example, punctuation mode would first be designated, after which the letter Q would be entered. Where multiple punctuation marks have the same initial letter, the most frequently occurring one is used by default. If this is not correct, the next most frequency punctuation mark beginning with that letter may be substituted by pressing “A,” and so forth, until the correct punctuation mark is displayed. (Here it is assumed that a punctuation mark will not normally be followed with one of the letters having “A” as the initial symbol.)

Cursoring may be performed using the keys bearing the “ [symbol] ”, “ [symbol] ”, “<”, and “>” symbols. Cursor mode may be entered (or exited) as described above, or by pressing one of the foregoing keys for a perceptibly longer period of time than normal.

In one embodiment, cursor mode continues until the user presses a “non-cursor” key—one that's not <, >, [symbol] , or [symbol] . So, to cursor to a spot and then enter a letter that begins with one of these symbols, it is necessary to backspace first to exit cursor mode, re-enter the deleted character if needed, then enter the desired letter.

Furthermore, any of various pointing devices may be integrated with the keypad, for example the “pointing stick” popularized by IBM or a miniature track-marble. Such a pointing device may be integrated with or in the vicinity of the “space” key, for example. Alternatively, the space key may be made to operate in similar fashion as a pointing stick. In this instance, a small boundary space is provided around the space key (for example, by making the space key slightly smaller than other keys), and the space key is provided with a “sticky” tactile surface (which also causes the space key to serve as a tactile reference point). The key (“pointing key”) is adapted to be moved by the finger in any desired direction, allowing for pointing to be performed in similar manner as a pointing stick. However, the basic form of the key remains unchanged and distinct from that of the pointing stick.

Alternatively, one or more keys may be made touch-sensitive, allowing for touch-pad-like operation.

By incorporating a pointing device into the keypad, the present input method becomes well-adapted for mobile web browsing.

An additional technique may be used for web browsing. As previously described, punctuation marks may be entered by entering the initial letter of a desired punctuation mark. In like manner, many web page links will have text associated with them and may be selected by entering the initial letter of the desired link. If multiple links have the same initial letter, these links may be high-lighted as a signal to the user to input the next letter in the desired link. Furthermore, from the standpoint of the web page designer, link text may be made conditional on the type of device to which the web page is to be sent such that, if the web page is to be sent to a mobile device, link text may be made visible that might otherwise remain hidden were the web page to be sent to a desktop or laptop machine, for example. This design measure will enhance the usefulness of this manner of mobile device web browsing. The browser is modified to, when a page is received, form a link text table. When character input is received, if a received character corresponds to a unique link text table entry, the link is followed. If the character corresponds to multiple link text table entries, the link text for these entries is highlighted, prompting the user to make a further entry.

FIG. 4 illustrates a generic hardware arrangement with which the present input system may be used. A keypad (or keypads) like that previously described is coupled to a suitable controller. Based on user inputs, the controller forms an output stream that is sent to a device. The device displays information on one or more displays. The output stream may identical to that of a standard keyboard. The behavior of the controller is such as to realize the functions previously described.

In the embodiment of FIG. 1, the keys 7-11 may be assigned the following functions:

| | |
|---|---|
| 7: | Return/? |
| | Press to enter a return. Press after Shift to enter |
| | a question mark. |
| 8: | Space/punc |
| | Press to enter a space. Press after Shift to enter |
| | punctuation mode, described below. |
| 9: | Period/comma |
| | Press to enter a period. Press after Shift to enter |
| | a comma. Enter two periods to cause a colon |
| | to be entered. Enter a period followed by a |
| | comma to cause a semicolon to be entered. |
| | Enter three periods to cause ellipsis to be entered. |
| 10 (*): | Backspace/curs |
| | Press to delete the last character. Press after |
| | Shift to enter or exit cursor mode using up, |
| | down, right and left arrow symbols (keys 1- |
| | 3 and 5). |
| 0: | Num/@. Press and release prior to pressing |
| | a single number key. Press twice for num lock. |
| | Press twice again to release num lock. Press |
| | after Shift to enter @. |
| 11 (#): | Shift. Press and release prior to entering an |
| | uppercase letter or to select the upper character |
| | on a key. Press twice for caps lock. Press |
| | twice again to release caps lock. |

Punctuation may be provided for through a combination of explicit punctuations keys, use of the symbols on keys 1-6 as “literals,” and morphological similarity, as presently explained.

In the example of FIG. 1, the punctuations marks found on keys 7-12 include the following: ?, period, comma, *, @ and #. A period is entered simply by pressing key 9. The punctuations marks ?, @ and comma are entered by first pressing the Shift key, then pressing the key corresponding to the desired punctuation mark. The punctuation marks * and # are entered by first pressing the Num key (since they are in the position of the number on the numbered keys), then pressing the key corresponding to the desired punctuation mark.

The punctuation marks ˆ, >, <, − and | are entered by first pressing the Shift key, followed by the Punc key, then pressing the key corresponding to the desired punctuation mark.

The remaining punctuation marks found on a standard computer keyboard are entered using morphological similarity, as follows:

| | |
|---|---|
| ( | In Punc mode, press < twice. |
| ) | In Punc mode, press > twice. |
| [ | In Punc mode, press < three times. |
| ] | In Punc mode, press > three times. |
| { | In Punc mode, press < four times. |
| } | In Punc mode, press > four times. |
| $ | In Punc mode, press \| twice. |
| / | In Punc mode, press \| three times. |
| % | In Punc mode, press \| four times. |
| \ | In Punc mode, press \| five times. |
| -- | (Dash) |
| | In Punc mode, press - twice. |
| _{—} | (Underscore) |
| | In Punc mode, press - three times |
| ˜ | In Punc mode, press - four times. |
| = | In Punc mode, press - five times. |
| + | In Punc mode, press - six times. |
| & | In Punc mode, press - seven times (exception |
| | to strict morphological similarity). |
| ' | (Apostrophe/single quote) |
| | After pressing Shift, press the comma key twice. |
| “ | (Double quote) |
| | After pressing Shift, press the comma key three times. |
| \grave{ } | (Grave accent) |
| | After pressing Shift, press the comma key four times. |
| : | Press period twice. |
| ... | Press period three times. |
| ! | Press period four times. |
| ; | Enter period followed by comma. |

The foregoing arrangement may be used in lieu of or in addition to other arrangements described herein.

An otherwise unused key combination (e.g., >, <) may also be used to designate a command mode as described later.

A help graphic like that of FIG. 2 may be displayed during use of a device, for example at the bottom of the display. (The user may be able to display or hide the help graphic as desired.) In FIG. 2, a dot is attached to the first symbol of the combination to make clear to the user which symbol is entered first. FIG. 5 shows an alternative help graphic. The graphic shows the letters of the alphabet as formed by the symbols ˆ, v, <, >, − and |. The letters D and F are shown as reversed images (or in color, if available) since, in the embodiment described, their constituent symbols are entered in the reverse order as compared to the expected order, i.e., >, | (not |, >) for D and <, | (not |, <) for F. Various other devices may be used to distinguish symbols or letters, for example color, shading, line weight, etc.

Although the foregoing embodiment using six symbols each on separate keys is presently preferred, note that it is possible using only five keys (rather than six) to input 25 unique letters—all but one of the letters of the alphabet. The letter Q, for example, may be provided for separately as described below. A sixth key may be a dedicated space key. Furthermore, the functions of other keys (e.g., backspace, period and return) may be reassigned, as follows. Period and return may be entered using multiple spaces. In this alternative embodiment, entering two spaces followed by a letter capitalizes that letter. Entering three spaces followed by a letter causes a period and a return to be entered after the previous letter, and capitalizes the following letter. Period and return may also be entered from a list of common punctuation marks as described later. Backspace may be entered by pressing the space key and, before releasing the space key, pressing any other key, once for a single backspace or multiple times for multiple backspaces. Hence, a full complement of keyboard functions may be realized using a keypad having only six keys.

Multiple Key Presses at a Time

In the preceding alternative embodiment, backspace was entered by pressing the space key and, before releasing the space key, pressing any other key. This technique of using multiple key presses at a time is common with computer keyboards and may also be used together with the present Simile input method to speed text entry by entering common punctuation marks, common words, and common letter combinations.

To enter any of a number of common punctuation marks (including return), press the space key and, before releasing the space key, press any other key, as if entering backspace. Keeping the other key pressed, release the space key. A list of common punctuation marks is displayed with the first highlighted. Releasing the other key at this point would cause the first punctuation mark to be selected and entered. Pressing the space key again highlights the second punctuation mark in the list. Highlight the desired punctuation mark and enter it by releasing the other key. The picture sequence of FIG. 8 illustrates this technique.

Because the technique of pressing and holding a key, pressing another key and holding that key, releasing the first key and possibly pressing the first key again one or more times can be used frequently, it is given a special name—reversing the roles of the keys. (If it helps to remember, while one key is held and another key is pressed one or more times, the other key functions as an iterator. When the roles of the keys are reversed, the key that would normally be the iterator is held down, and the first key then becomes the iterator.)

Entering Common Words; Entering Punctuation Marks

The following discussion assumes a keypad layout such as that of FIG. 9.

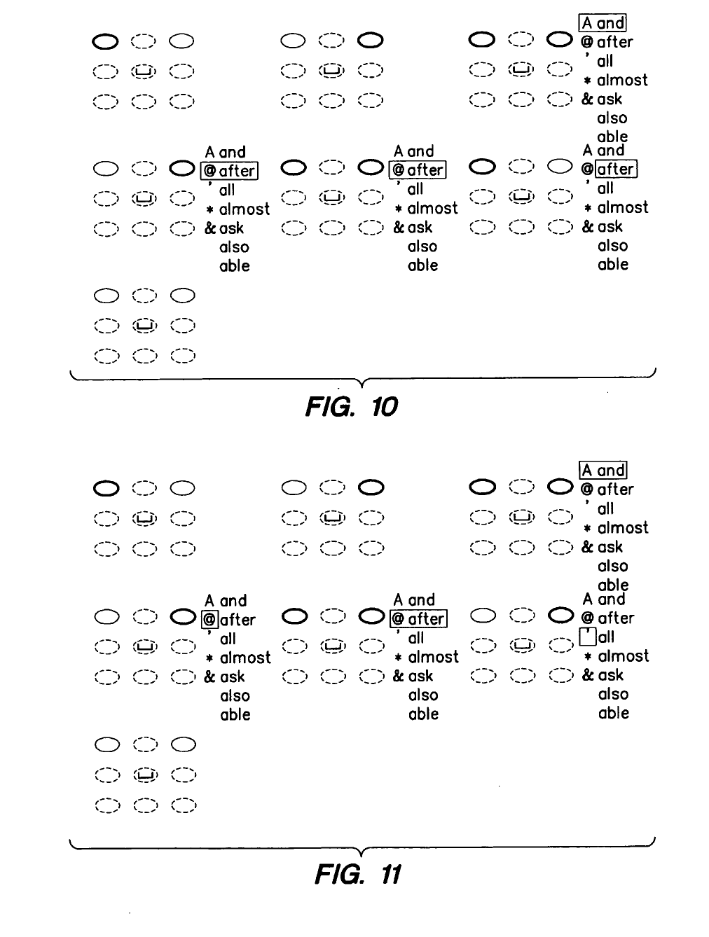

To enter a common word or a punctuation mark, first enter the beginning letter of the word or punctuation mark and hold down the second key of the key combination. Then press another other key, to the right or to the left. Two lists are displayed side-by-side of words and punctuation marks, with the first word and the first punctuation mark highlighted. If the word is displayed on the right and the punctuation mark on the left, then to select the word, release the right key first, then the left key. To select the punctuation mark, release the left key first, then the right key. To highlight the next pair, press the other key again. Be sure to keep the other key pressed long enough to decide which if either of the highlighted pair should be selected. The picture sequences of FIG. 10 and FIG. 11 illustrate this technique.

To make capitalization easy, the uppercase letter may be the first entry in the punctuation list.

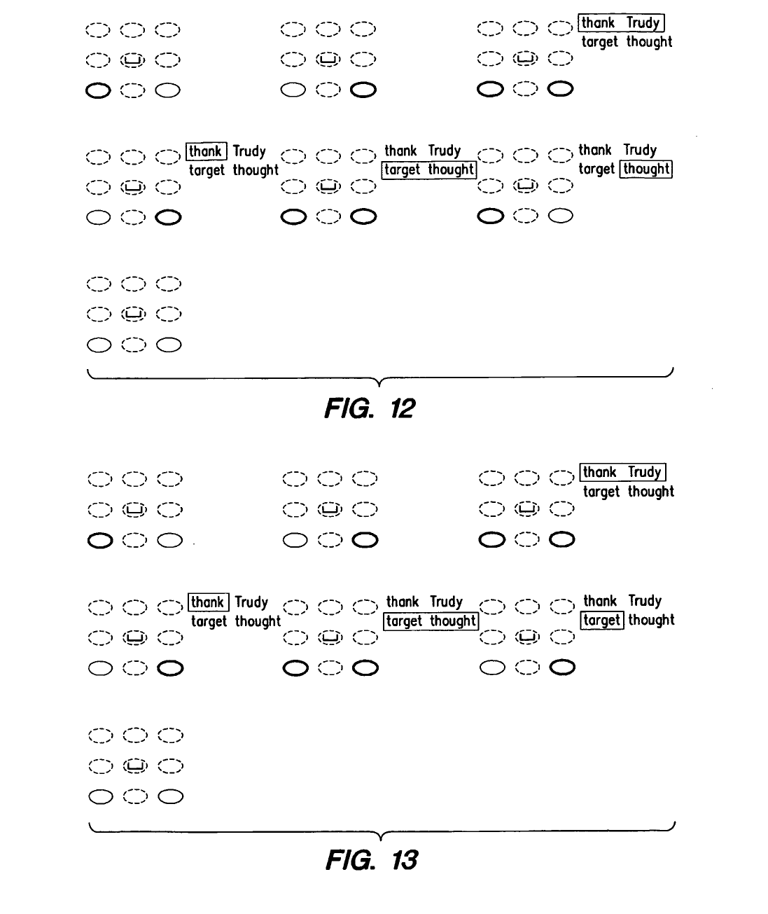

The common words in this list are those most common in everyday use. Two other word lists may also kept, one (MyWords) for words that may be common to the user but not the population at large, another (DocWords) for words not on the other word lists but used repeatedly in the current document. To access these lists, enter the beginning letter of the word and hold down the second key of the key combination. Then press another other key, to the right or to the left. Now reverse the roles of the two keys. The two lists MyWords and DocWords are displayed side-by-side. Select an entry the same way as with the common word list. The picture sequences of FIG. 12 and FIG. 13 illustrate this technique.

Entering Common Letter Combinations

Common letter combinations (partial words) of 3-6 letters may be entered in a similar way. To access these lists, enter the beginning letter of the word. Press the second key of the key combination an extra time and hold it down. Then press another other key, to the right or to the left. Two lists, one of three-letter combinations and one of four-letter combinations, are displayed side-by-side. Select an entry the same way as with the common word list. For five and six-letter combinations, reverse the roles of the keys.

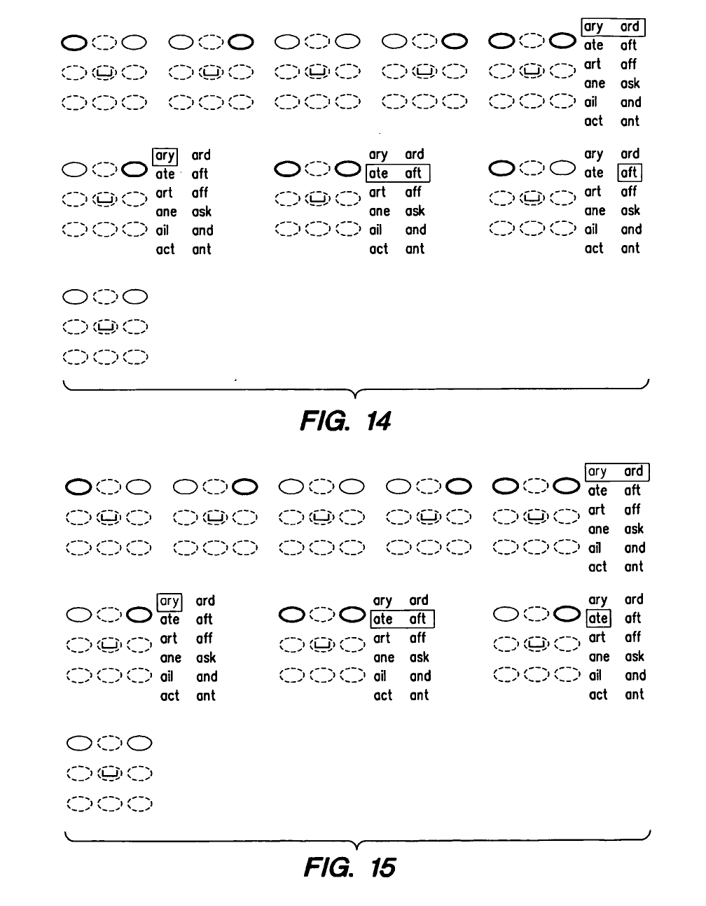

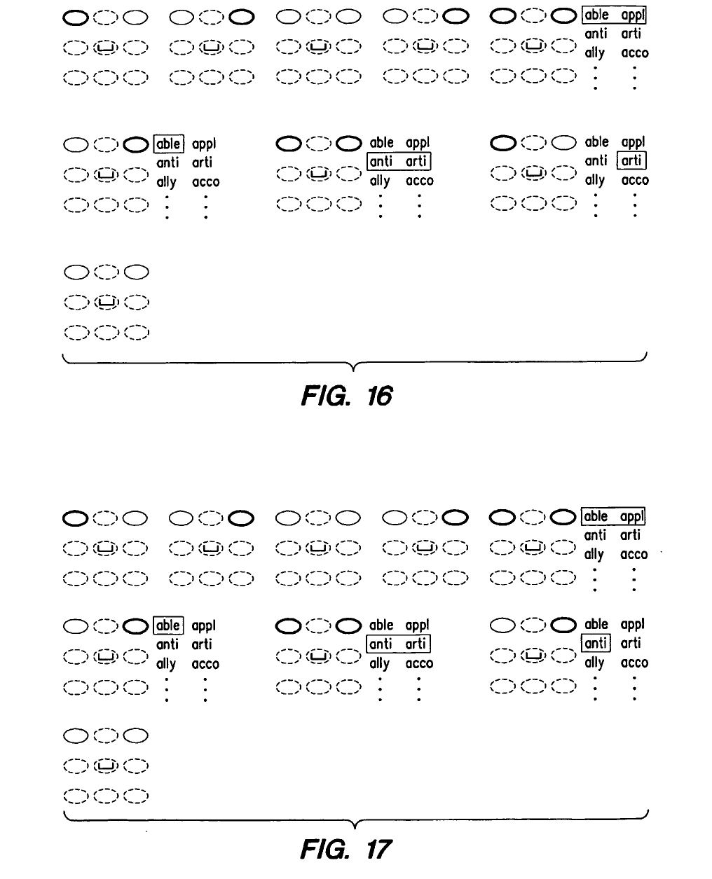

Alternatively, 5 and 6 letter combinations may be dispensed with, allowing for twice the number of (more common) 3 and 4 letter combinations. The picture sequences of FIG. 14, FIG. 15, FIG. 16, and FIG. 17 illustrate this technique.

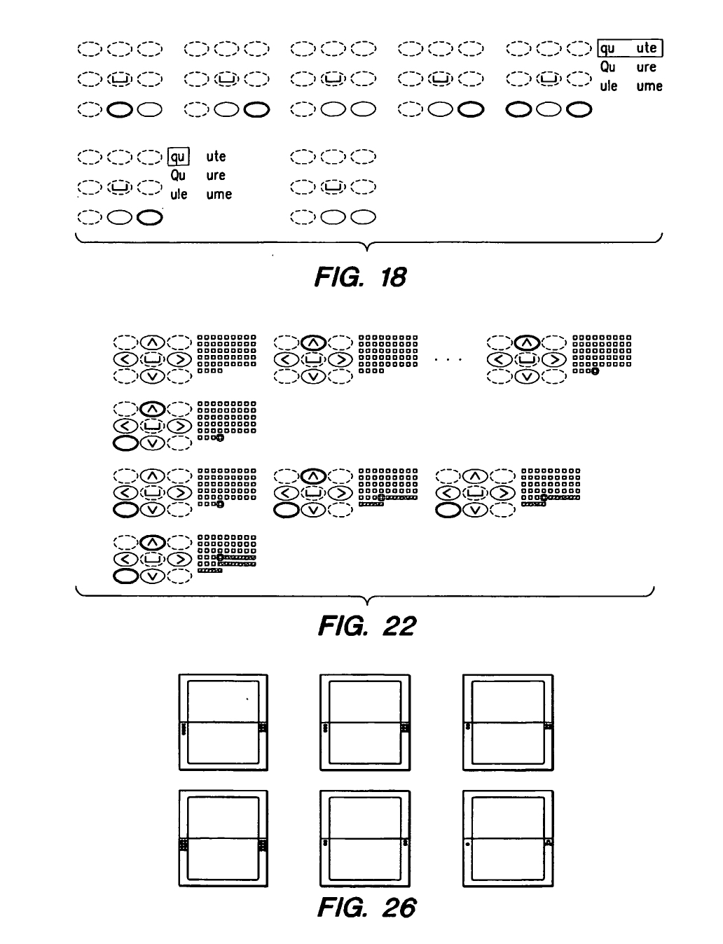

To allow for text input using 6 keys (or fewer), it may be convenient to treat the letter Q as a two letter combination of the letter U (since in the English language, U invariably follows Q, and the U can readily be deleted in those infrequent instances in which it is not required). FIG. 18 illustrates this approach.

The use of multiple simultaneous key presses offers the possibility of a very rich “input language.” For example, a letter may be designated while signalling additional follow-on input in any of at least four different ways. Take for example the letter C (input as d, l). This letter may be designated while signalling additional follow-on input in any of the following ways:

1. Press d and hold; press l.

2. Press d; press l and hold.

3. Press d; press l; press l again and hold.

4. Press d; press l; press d again and hold.

Each of the foregoing possibilities may trigger a different device response, e.g., word input, letter combination input, punctuation input, command input or menu name input, etc.

The capability of multiple simultaneous key presses is not required, however, in order to provide features that speed up text input. In one embodiment, a lookup operation is performed as follows. The user enters one or more letters (e.g., C) and then signals lookup by a particular user input designated for this purpose. In an exemplary embodiment, this is signalled using an otherwise unused key combination (r, l). A list is displayed of words that begin with the inputted letter for simplicity, this single list may consolidate together words from all of the lists previously described (common words, MyWords, DocWords). In this embodiment, the list is displayed as multiple columns, e.g., two. A key on the right-hand side of the keypad is used to iterate down the right-hand column, and a key on the left-hand side of the keypad is used to iterate down the left-hand column. The key not used to iterate is used to perform selection, hence the left-hand key for the right-hand column and the right-hand key for the left-hand column. The desired word may not be found on the list, in which case pressing backspace dismisses the list. Alternatively, one or more further letters may be entered, causing there to be displayed a new list of words having the expanded stem.

Numbers

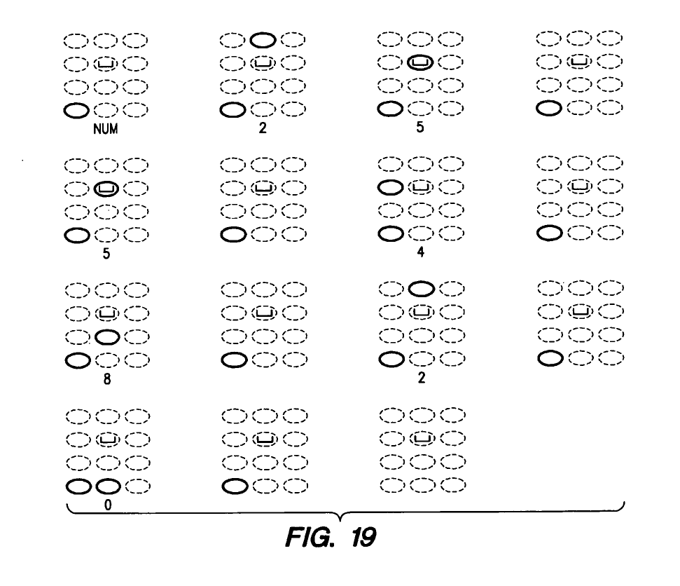

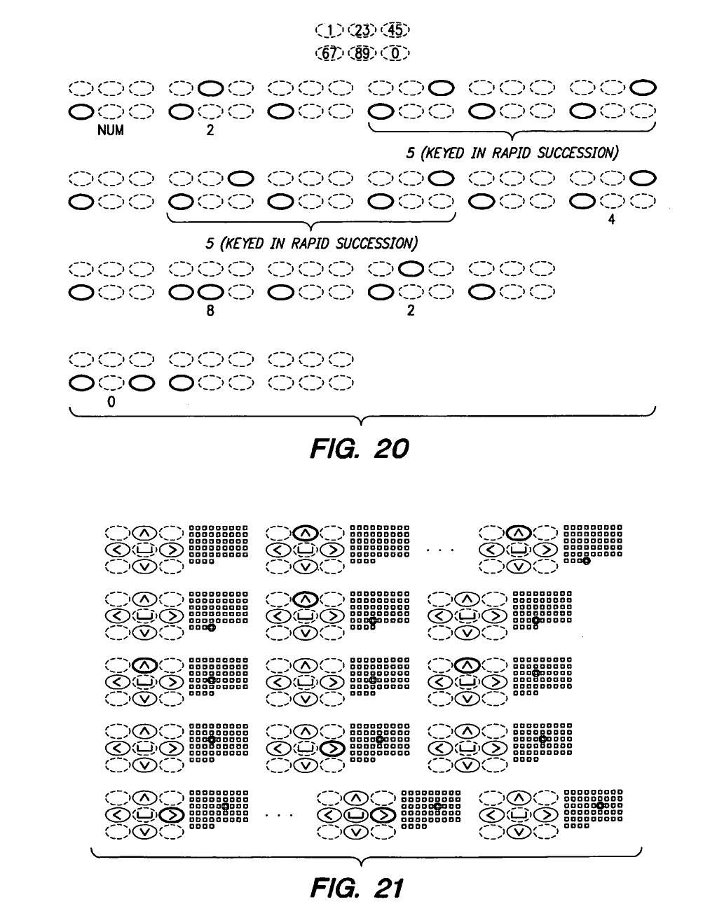

Numbers may be entered by first pressing and holding any key, then pressing the desired number key. To enter multiple numbers in succession, hold down the first key until the last number has been entered (or, if needed, release that key and press and hold down a different key.) In some configurations having a reduced number of keys, two (or more) numbers may be assigned to the same key. In this instance, a number may be entered by pressing that key once or multiple times as in the well-known one-tap, two-tap, three-tap system sometimes used for text input. The picture sequences of FIG. 19 and FIG. 20 illustrate this technique.

Cursoring, Pointing

The keys marked ˆ, v, >, and <may be used as cursor keys. Press for a prolonged period a desired cursor key. Cursor mode is then entered, as indicated by a blinking cursor. Each successive press of a cursor key cursors advances the cursor one row or space in the corresponding direction. Pressing a cursor key again for a prolonged period exits cursor mode. To select text, press and hold a non-cursor key while cursoring. The picture sequences of FIG. 21 and FIG. 22 illustrate these techniques.

Alternatively, or in addition, a trackwheel and escape key as in the RIM Blackberry device may be provided.

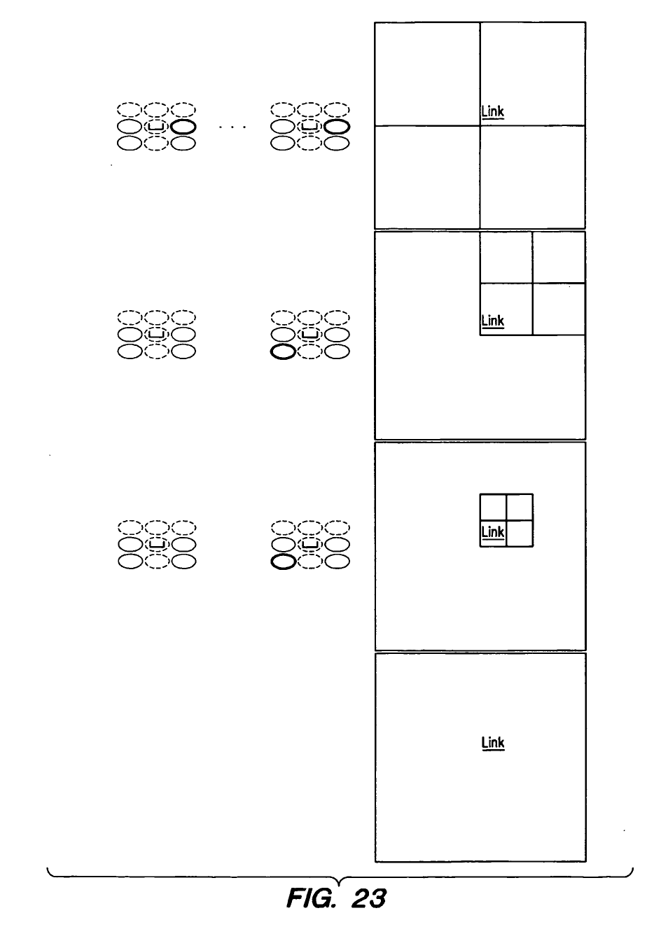

For graphical displays, a pointing function may be provided using four keys, for example the lower-most, right-most two keys and lower-most, left-most two keys (or a different set of four keys designated by color or some other device). Pointing is achieved by repeatedly dividing the screen into four parts (recursive quadrisection) and pressing the key corresponding to the part containing the desired point on the screen. To begin pointing, press and hold for a prolonged period the one of the four keys that corresponds to the desired quadrisection. (If as between graphical selection and cursoring the desired operation is not clear from context, press in addition any other key.) A faint grid is displayed dividing the display area into quadrisections, indicating that pointing mode has begun. If it appears based on the grid that the correct quadrisection was selected, keep the key depressed for a moment longer. A faint grid is then displayed dividing the selected quadrisection into smaller quadrisections. (If the wrong quadrisection was selected initially, simply press the key corresponding to the correct quadrisection.) Keep selecting the quadrisection containing the desired visual element on the screen. After several selections, one of the quadrisections will contain as the desired visual element as the only visual element eligible for selection. Selecting that quadrisection will cause that visual element to be selected. The picture sequence of FIG. 23 illustrates this technique.

Of course, a number of sections different than four may be used (e.g., two, six, etc.)

Recursive quadrisection may be used for coarse graphical selection or cursor positioning, and a pointing stick or pointing key may be used for fine selection or positioning.

Commands

Commands may be entered by pressing a key sequence to enter a command mode, then pressing the key combination for the first letter of the name of the command. For example, command mode may be entered by pressing either the / key or the \ key, then pressing the same key again and holding it down. Command options are then displayed. While still holding down the previous key, any other key may be pressed to advance through the list of commands. The commands may be individual commands or command menus and may be accessed individually or by grouping. For example, the Save command could be accessed under the letter S as well as under the letter F representing a File menu.

Just as the Space key may be used to access common punctuations marks, so also the Space key may be used to access command menus (regardless of the beginning letter).

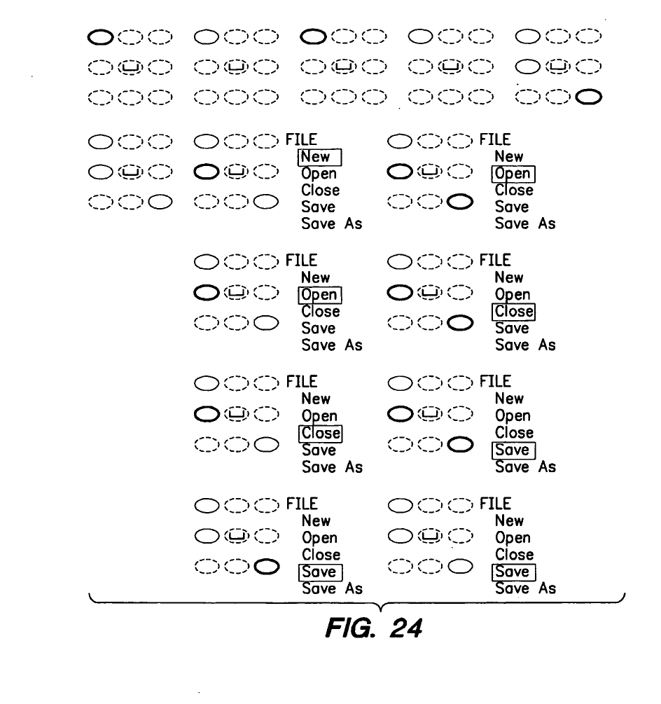

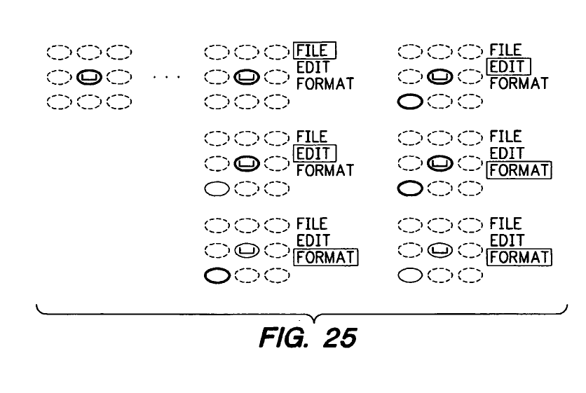

The picture sequences of FIG. 24 and FIG. 25 illustrate an example of these techniques.

Device Configurations

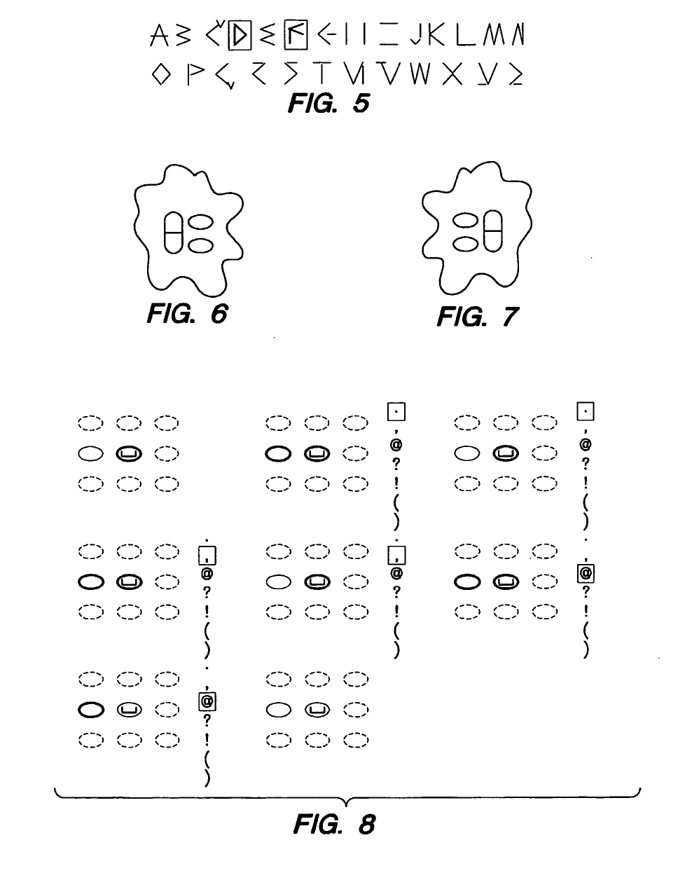

Reducing the number of keys required for text entry increases compactness and makes possible new device configurations. No-look operation further increases flexibility. A typical device may have as few as four keys used for text input or as may as sixteen and may have an even number or odd number of keys. (Using only four keys, additional “virtual” keys may be realized through two-key simultaneous keying, i.e., chord keying.) The keys need not be positioned all together. Rather, keys operated by different thumbs (e.g., one thumb operating two keys for purposes of inputting letters and the other thumb operating four keys) may be positioned on opposite sides of a display screen, for example, as illustrated in FIG. 26. In one embodiment, a short vertical “space bar” may be provided in the form of two abutting keys provided next to the two keys operated by the one thumb, as illustrated in FIG. 6 and FIG. 7.

DTMF

Existing telephone applications rely on DTMF tones. For compatibility with such systems, it may be useful for at least the first letter on each key of a conventional keypad to also appear on Simile keypads. Alternatively, the mobile electronic device may be provided with a DTMF translator such that, regardless of the key sequence used to enter a letter, the usual DTMF tone for that letter is emitted. Of course, as time passes, telephone applications may become “Simile-aware,” in which case no translation would be required and the ambiguity associated with conventional telephone applications would be avoided. At the beginning of such an application, an opportunity may be provided to select conventional operation or Simile-aware operation.

Furthermore, Simile tones may be used with or without Simile input to convey messages disambiguously via a voice channel. For example, a virtual business card, or .vcf file, might be transmitted in connection with telephone conversation, by transmitting each character as a pair or tuple of tones.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

What is claimed is:

1. A method of controlling a mobile electronic device to receive text input, comprising, detecting presses of no more than N keys of some number of keys, receiving input of most or all of the letters A-Z of the alphabet by, for at least some letters, inputting that letter in response to exactly two sequential key presses.

2. The method of claim 1, wherein most or all of the letters are input in response to exactly two sequential key presses.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method of user assistance for text input to a mobile electronic device having a keypad and a display, comprising displaying most or all of the letters A-Z, each letter being displayed as a combination of two separate symbols appearing on separate keys of the keypad.

17. The method of claim 16, wherein one symbol of said combination of two symbols is distinguished from the other using at least one of the following: color, shading, line weight, dotting.

18. The method of claim 17, wherein said one symbol distinguished from the other is found on a key that is to be pressed first in order to enter a letter.

19. (canceled)

20. A method of controlling a mobile electronic device to receive graphical selection or cursor positioning information, comprising:
displaying an element on a display of the electronic device;
logically dividing the display into sections;
detecting a user input corresponding to a section of the display in which the display element is displayed;
logically dividing a section previously selected into smaller sections; and
repeating the immediately preceding steps of detecting and logically dividing as necessary.

21. The method of claim 20, further comprising indicating on the display said sections for selection by the user.

22. The method of claim 21, wherein the sections are quadrants.

23. The method of claim 20, wherein the user inputs are key presses or key combinations.

24. (canceled)

25. (canceled)

26. (canceled)

27. A keypad for use with a mobile electronic device, the keypad having an arrangement of keys, wherein respective keys have formed thereon respective indicia substantially as follows: left angle, right angle, up angle, down angle, horizontal line, vertical line.

28. A keypad for use with a mobile electronic device, the keypad having an arrangement of keys, at least four of the keys having raised indicia formed thereon.

29. The apparatus of claim 28, wherein at least six of the keys have raised indicia formed thereon.

30. (canceled)

31. (canceled)

32. (canceled)

33. A mobile electronic device comprising a housing, a display and a keypad means having an arrangement of key means, wherein respective key means have formed thereon respective indicia substantially as follows: left angle, right angle, up angle, down angle, horizontal line, vertical line.

34. The apparatus of claim 33, further comprising a controller for controlling said keypad means, the controller recognizing various sequences in which multiple key means are sequentially activated as representing various corresponding letters or symbols of an alphabet.

35. The method of claim 34, wherein for each of the letters of the English alphabet, each letters is represented by sequential activation of exactly two key means.

36. (canceled)

37. (canceled)

38. (canceled)

39. (canceled)

40. (canceled)

41. (canceled)

42. (canceled)

43. (canceled)

44. (canceled)
